(19) United States
(12) Patent Application Publication
(10) Pub. No.: US 2011/0303653 A1
(43) Pub. Date: Dec. 15, 2011

(54) INDUCTION HEATING COOKER AND CONTROL METHOD THEREOF

(75) Inventors: Yun Bong CHUN, Yongin-si (KR); Kyung Suk Bae, Suwon-si (KR)

(73) Assignee: SAMSUNG ELECTRONICS CO., LTD., Suwon-si (KR)

(21) Appl. No.: 13/158,869

(22) Filed: Jun. 13, 2011

(30) Foreign Application Priority Data
Jun. 14, 2010 (KR) 10-2010-0056090

(51) Int. Cl. H05B 6/12

(52) U.S. Cl. 219/624; 219/626

(57) ABSTRACT

Disclosed herein are an induction heating cooker and a control method thereof in which heating coils on which a container is located are sensed, a display unit displays a region corresponding to the heating coils on which the container is located, the displayed region is selected by a user, an output adjustment unit as to the displayed region is displayed, and output of the corresponding heating coils is adjusted by adjusting the output adjustment unit. The induction heating cooker includes heating coils to heat the container, a display unit to display the sensed container or the output adjustment unit of the heating coils, and the output adjustment unit to adjust the output of the heating coils on which the container is located.

### CROSS-REFERENCE TO RELATED APPLICATIONS

This application claims the priority benefit of Korean Patent Application No. 10-2010-0056090, filed on Jun. 14, 2010 in the Korean Intellectual Property Office, the disclosure of which is incorporated herein by reference.

### BACKGROUND

1. Field

Embodiments relate to a state display method and operation of an induction heating cooker.

2. Description of the Related Art

A display unit and an operation unit of an induction heating cooker are capable of displaying and adjusting limited operation and output using segments and icons. The display unit and the operation unit are constituted by combinations of the segments, specific cooking icons, and dials, such as keys (tactile or touch keys, etc.). Most conventional induction heating cookers are provided with three, four, or five holes and do not have complicated operating methods, thus not requiring additional operation and display methods. That is, the conventional induction heating cookers are designated such that containers are heated only at set positions in the limited number of regions, and thus may be controlled using four or five adjustment units and the display unit.

However, if the number of containers to be heated is large or a container is not properly mounted on a cooking plate, the conventional induction heating cooker has a difficulty in heating the large number of containers and a difficulty in heating a desired container with a desired output.

Further, since a user firstly checks a position of a container located on the cooking plate with the naked eye and secondarily adjusts an output through an output adjustment unit separately installed, the conventional induction heating cooker may fail to select a desired container and to adjust the output corresponding to the selected container.

### SUMMARY

Therefore, it is an aspect to provide an induction heating cooker and a control method thereof in which a container located on heating coils is recognized, a region corresponding to the recognized container is displayed on a display unit having a proper size, and an output adjustment unit is adjusted, thereby allowing output of heating coils corresponding to respective containers to be easily adjusted.

Additional aspects will be set forth in part in the description which follows and, in part, will be obvious from the description, or may be learned by practice of the embodiment.

In accordance with one aspect, an induction heating cooker includes heating coils to heat a container, sensing units to sense the container located on the heating coils, a display unit to display the sensed container, and an output adjustment unit to adjust output of the heating coils.

### BRIEF DESCRIPTION OF THE DRAWINGS

These and/or other aspects will become apparent and more readily appreciated from the following description of the embodiments, taken in conjunction with the accompanying drawings of which:

FIG. 1 is a perspective view illustrating a configuration of an induction heating cooker in accordance with one embodiment;

FIG. 2 is a plan view illustrating an internal structure under a cooking plate of the induction heating cooker in accordance with the embodiment;

FIG. 3A is an exploded perspective view of an operation panel of the induction heating cooker in accordance with the embodiment;

FIG. 3B is a longitudinal-sectional view illustrating a configuration of a touch panel in accordance with the embodiment;

FIG. 3C is a block diagram illustrating a configuration of a display unit including of LEDs in accordance with the embodiment;

FIG. 4 is a plan view of the display unit illustrating regions corresponding to containers located on heating coils in accordance with the embodiment;

FIG. 5 is a plan view of an operation panel of an induction heating cooker, if a region displayed on the operation panel is touched to adjust output of heating coils on which a container is located, in accordance with one embodiment;

FIG. 6 is a plan view of an operation panel of an induction heating cooker, if a region displayed on the operation panel is touched to adjust output of heating coils on which a container is located, in accordance with another embodiment;

FIG. 7 is a plan view of an operation panel of an induction heating cooker, if a region displayed on the operation panel is touched to adjust output of heating coils on which a container is located, in accordance with a further embodiment;

FIG. 8 is a plan view of an operation panel of an induction heating cooker on which recognized containers are actually displayed in accordance with one embodiment;

FIG. 9 is a plan view of an operation panel of an induction heating cooker on which a state of a recognized container and an output adjustment unit are actually displayed in accordance with another embodiment;

FIG. 10 is a plan view of a display unit displaying remaining heat of an induction heating cooker after a container is removed in accordance with one embodiment;

FIG. 11 is a plan view illustrating setting of a recognition region by hand, if whether or not containers are located on heating coils is not recognized, in accordance with one embodiment; and

FIG. 12 is a flow chart illustrating an operating process of an induction heating cooker in accordance with one embodiment.

### DETAILED DESCRIPTION

Reference will now be made in detail to the embodiments, examples of which are illustrated in the accompanying drawings, wherein like reference numerals refer to like elements throughout.

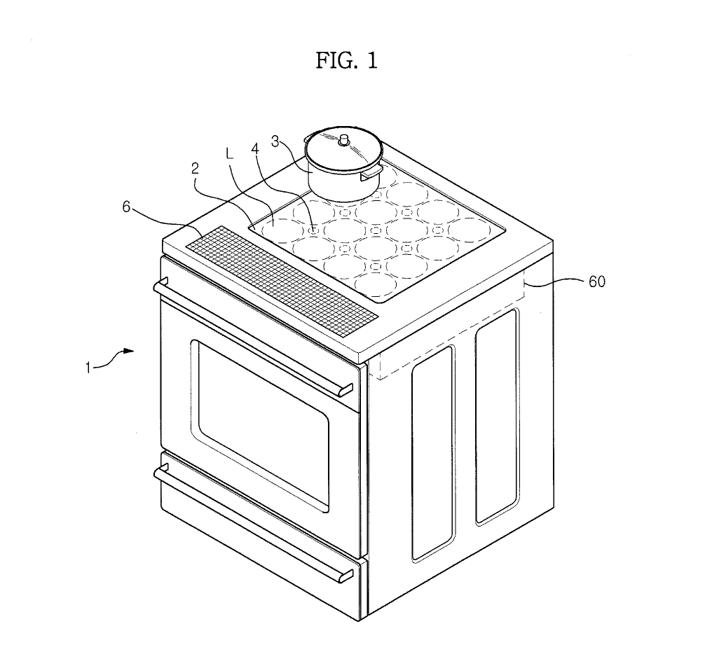

FIG. 1 is a perspective view illustrating a configuration of an induction heating cooker in accordance with one embodiment.

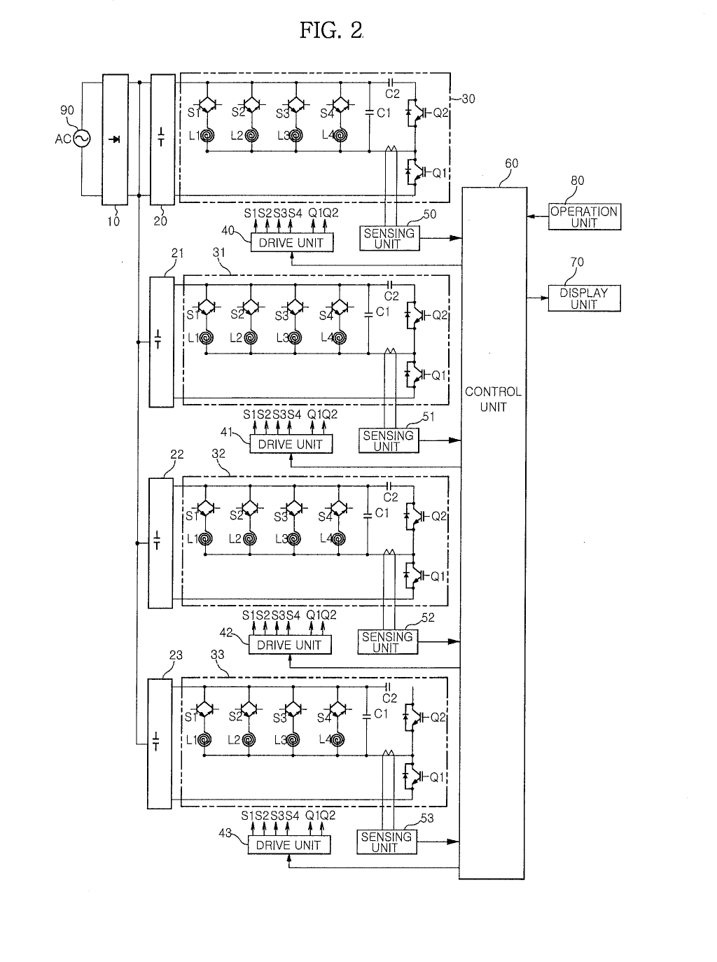

An induction heating cooker in accordance with the embodiment includes a case 1. A cooking plate 2 on which a container 3 is mounted is installed on the upper surface of the case 1. At least one heating coil L serving as a heat source to supply heat to the cooking plate 2 is installed under the cooking plate 2. In this embodiment, four heating coil groups (in FIG. 1, four heating coils L1˜L4 forming one heating coil group) arranged in a line are respectively operated by drive units 40˜43 (with reference to FIG. 2) operated by a control unit 60. Further, the heating coils L may be respectively operated by the drive units 40˜43 operated by the control unit 60. The heating coils L under the cooking plate 2 may be arranged in the shape of an N*N matrix. In this embodiment, the heating coils L are arranged in the shape of a 4*4 matrix.

Further, temperature sensors 4 to sense temperatures of the heating coils L or temperature of the cooking plate 2 are located under the cooking plate 2. The temperature sensors 4 sense temperatures of the heating coils L or temperature of the cooking plate 2, and transmit a sensed temperature signal to the control unit 60. The control unit 60 controls a display unit 70 or other display units based on the sensed temperature signal so as to display the sensed temperature(s) on the display unit 70 or other display units.

An operation panel 6 is located at a designated position of the upper surface of the case 1. The operation panel 6 may include the display unit 70, an operation unit 80, and a plate 5.

FIG. 2 is a plan view illustrating an internal structure under the cooking plate of the induction heating cooker in accordance with the embodiment.

The induction heating cooker in accordance with this embodiment may include a rectification unit 10, smoothing units 20˜23, inverter units 30˜33, the drive units 40˜43, sensing units 50˜53, the control unit 60, the display unit 70, and the operation unit 80.

The heating coil groups are independently driven by the inverter units 30˜33, respectively. Further, the respective heating coils L1˜L4 may be independently driven by the drive units 40˜43, respectively. The first heating coil group is driven by the first inverter unit 30, the second heating coil group is driven by the second inverter unit 31, the third heating coil group is driven by the third inverter unit 32, and the fourth heating coil group is driven by the fourth inverter unit 33. The heating coil groups and the inverter units 30˜33 may be prepared or provided in plural number to correspond to each other. Further, the respective heating coils L1˜L4 and the inverter units 30˜33 may be prepared in plural number to correspond to each other. FIG. 2 illustrates four heating coil groups, each of which includes four heating coils L1˜L4, and four inverter units 30˜33 to drive the four heating coil groups.

Each of the inverter units 30˜33 may include main switching elements Q1 and Q2, sub switching elements S1˜S4, and condensers C1 and C2. The main switching elements Q1 and Q2 alternately switch smooth voltage output from the smoothing unit 20,21,22, or 23 according to a switching control signal, and supply high-frequency power to the respective heating coils L1˜L4. The first condenser C1 and the second condenser C2 serve to cause current to flow in the respective heating coils L1˜L4.

When a region 100 corresponding to the heating coils L on which the container 3 is located and an output adjustment unit 200 are displayed on the operation panel 6 based on current sensed by the sensing units 50˜53 and a user selects the displayed region 100 and the displayed output adjustment unit 200 through the operation panel 6, the control unit 60 transmits a control signal to adjust output of the heating coils L on which the container 3 is located to a corresponding one of the drive units 40˜43, and the corresponding drive unit 40, 41,42, or 43 drives the respective heating coils L1˜L4.

Further, the sensing units 50˜53 employ various types of sensors, such as voltage sensors, pressure sensors, and infrared sensors, in addition to current sensors to sense current, and sense the container 3 located on the heating coils.

When a signal is input to the control unit 60 through the operation panel 6, the control unit 60 controls operation of the inverter units 30˜33 through the drive units 40˜43 so that current sequentially flows to the respective heating coils L1˜L4 of the respective heating coil groups to detect whether the container 3 is located at the respective heating coils L1˜L4 of the respective heating coil groups.

Further, the control unit 60 judges whether the container 3 is located at the respective heating coils L1˜L4 of the respective heating coil groups according to current values sensed by the sensing units 50˜53.

Further, in the case of the heating coils for which it is judged that the container 3 is located thereon, the control unit 60 displays data of the container 3, located on the heating coils L1˜L4 of the respective heating coil groups, on the operation panel 6. Thereby, the user inputs the heating coils on which the container 3 is located through the output adjustment unit 200 displayed on the operation panel 6. The control unit 60 sequentially supplies high-frequency power to the heating coils on which the container 3 is located, thereby heating the container 3 located on the corresponding heating coils.

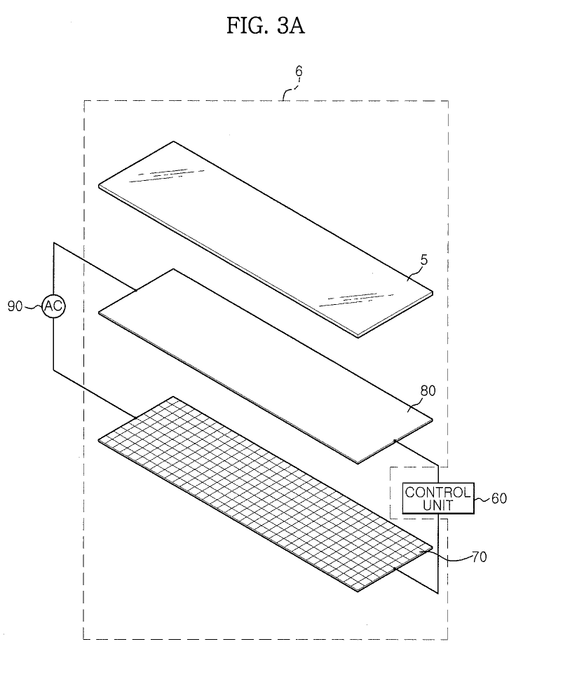

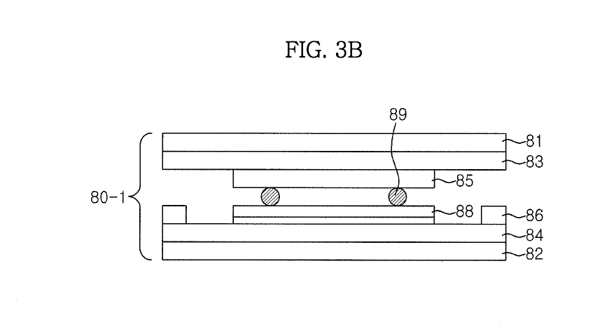

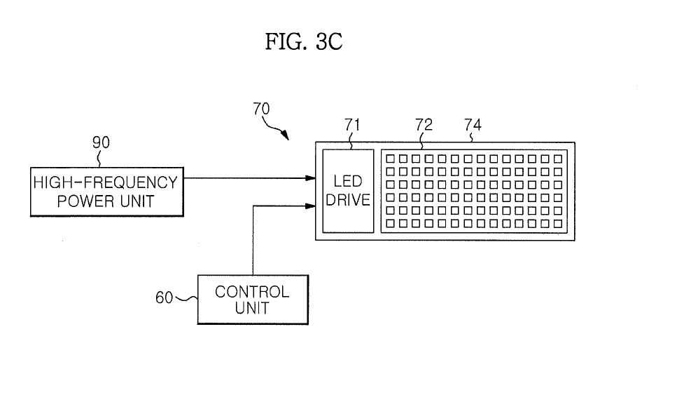

FIG. 3A is an exploded perspective view of the operation panel of the induction heating cooker in accordance with the embodiment.

In the operation panel 6, the plate 5 is located at the uppermost position, and the operation unit 80 is located under the plate 5. Then, the display unit 70 is located under the operation unit 80. A high-frequency power unit 90 to supply power is connected to the operation unit 80 and the display unit 70. Further, the control unit 60 to control the operation unit 80 and the display unit 70 is connected to the operation unit 80 and the display unit 70.

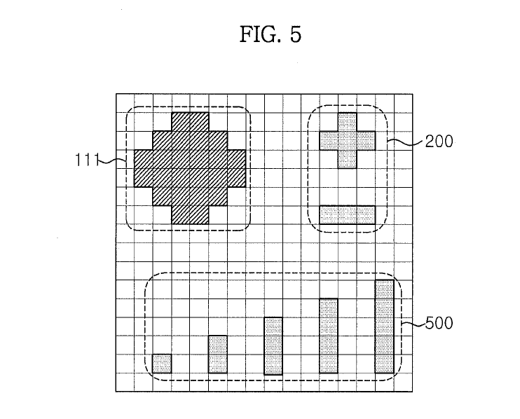

The display unit 70 may be formed in various types, such as liquid crystal displays (LCDs), plasma display panel (PDPs), electroluminescence (ELs), cathode ray tube (CRTs), and LEDs. The display unit 70 displays designated regions of containers 3 located on the heating coils L or output adjustment units 200 and/or 500 (shown in FIG. 5) of the corresponding heating coils L.

The operation unit 80 may be formed in various types being capable of receiving an input signal from a user, such as a touch panel. The operation unit 80 may be formed in any one type of a resistive type, a capacitive type, an IR sensor type, and an optical sensor type. However, it is not limited thereto.

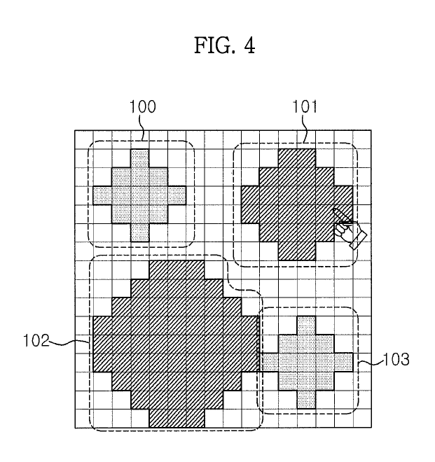

The operation unit 80 transmits a signal of a container 3, selected by the user, or a signal of the output adjustment unit 200 (in FIG. 4), adjusted by the user, to the control unit 60, and the control unit 60 controls output of the heating coils L based on the signal. The plate 5 may be made of a transparent material.

FIG. 3B is a longitudinal-sectional view illustrating a configuration of a touch panel operation unit in accordance with the embodiment.

The touch panel operation unit 80-1 is configured such that an upper transparent substrate 81 provided with an upper electrode 83 formed thereon and a lower transparent substrate 82 provided with a lower electrode 84 formed thereon are with a designated space therebetween. When an input unit, such as a pen or a finger, contacts one point of the upper substrate 81 provided with the upper electrode 83 formed thereon, the upper electrode 83 formed on the upper substrate 81 and the lower electrode 84 formed on the lower substrate 82 are electrically connected to each other, a voltage value changed by a resistance value or a capacitor value at this position is read, and then the control unit 60 searches positional coordinates according to a change of a potential difference.

The touch panel operation unit 80-1 is installed on the display surface of the display unit 70, and is used as a command input unit. The touch panel operation unit 80-1 may be divided into a display region corresponding to the display surface of the display unit 70, and a dead space region (not shown) formed at the periphery of the display region to surround the display region. The upper and lower substrates 81 and 82 are bonded to each other at the dead space region by an insulating adhesive agent (not shown), and the transparent electrodes 83 and 84 are formed on the inner surfaces of the poly ethylene terephthalate (PET) substrates 81 and 82 under the display unit 70. Here, the substrates 81 and 82 are bonded to each other at the dead space region by the insulating adhesive agent with a space formed therebetween. Further, first and second metal electrodes 85 and 86 are formed on the upper and lower substrates 81 and 82, respectively. When a pen or a finger contacts one point of the upper substrate 81, the transparent electrodes 83 and 84 contact each other at the position of this point, and a voltage value changed by a resistance value at this position is output. The first metal electrode 85 formed on the upper substrate 81 and a contact line 88 formed on the lower substrate 82 contact each other by a conductive adhesive agent 89.

FIG. 3C is a block diagram illustrating a configuration of the display unit including LEDs in accordance with the embodiment.

Although this embodiment illustrates the display unit 70 using LEDs, the display unit 70 is not limited thereto but may include LCDs, PDPs, or CRTs. The display unit 70 includes the high-frequency power unit 90, the control unit 60, and an LED unit 74. The LED unit 74 includes an LED drive 71 and a plurality of LED arrays 72. The control unit 60 provides a control signal to the respective LED arrays 72 in the LED unit 74, respectively. The control signal may be a digital signal or an analog signal generated to maintain color temperature and brightness of the LED arrays 72 in the LED unit 74.

The plurality of LED arrays 72 includes LEDs arranged in a matrix (line of a designated number*column of a designated number) on a designated area of a printed circuit board (PCB). The LED drive 71 may drive the LEDs of the respective LED arrays 72 using a constant voltage drive method or a constant current drive method. However, it is not limited thereto.

FIG. 4 is a plan view of the display unit illustrating regions corresponding to containers located on heating coils in accordance with the embodiment.

The display unit 70 displays designated regions corresponding to containers 3 located on the heating coils, if four containers 3 are placed on the cooking plate 2 by a user. When a region 101 is selected by the user, the display unit 70 is converted into any one of screen states, as shown in FIGS. 5 to 7.

The display unit 70 is provided in a ratio of the length to the width of the cooking plate 2 on which the containers 3 are placed. If the cooking plate 2 is greater than the display unit 70, the display unit 70 is provided in a reduced size in the ratio of the length to the width of the cooking plate 2.

Further, the display unit 70 displays the sensed containers 3 at positions corresponding to the actual positions of the containers 3 on the cooking plate 2. That is, the display unit 70 displays the containers 3 in a manner of mimicking the containers 3 located on the cooking plate 2.

FIG. 5 is a plan view of an operation panel of an induction heating cooker, if a region displayed on the operation panel is touched to adjust output of heating coils on which a container is located, in accordance with one embodiment.

The operation panel 6 converted by user selection displays a region 111 corresponding to the container 3 located on the heating coils L and the output adjustment units 200 and/or 500. The region 111 and the output adjustment unit 200 may be disposed at one portion of the display panel 6. The displayed region 111 may maintain the shape of the region 101 prior to the user selection, or may be reduced or enlarged from the shape of the region 101 prior to the user selection.

The output adjustment unit 200 is formed in the shape of + and − marks such that the user may adjust output of the corresponding heating coils. Otherwise, the output adjustment unit 200 may be formed in various shapes, such as ↑ and ↓ marks.

The output adjustment unit 500 may be formed in the shape of sliding bars indicating output applied to the corresponding heating coils, and the longer the length of the sliding bar, the higher the output of the corresponding heating coils. Further, shapes, colors, and disposition order of the sliding bars may be variously modified.

Further, the operation panel 6 may display either of the output adjustment units 200 and/or 500 or display two or more of the output adjustment units 200 and/or 500.

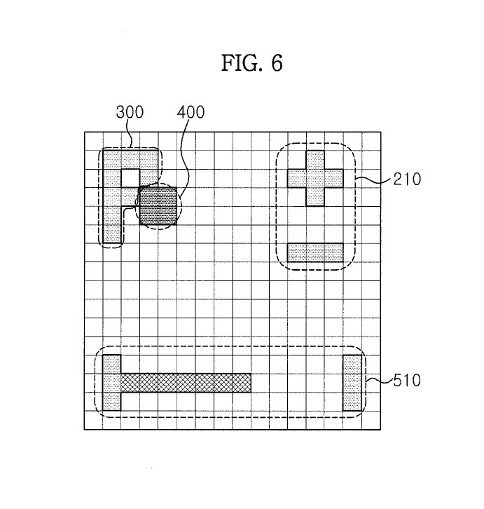

FIG. 6 is a plan view of an operation panel of an induction heating cooker, if a region displayed on the operation panel is touched to adjust output of heating coils on which a container is located, in accordance with another embodiment.

When a user selects one of the regions displayed on the operation panel 6 in FIG. 4 by hand, an output adjustment unit 210 in the shape of + and − marks and an output adjustment unit 510 in the shape of slides are displayed. The two output adjustment units 210 and/or 510 may be formed in various types, as shown in FIG. 5. Further, a display 400 corresponding to data of the corresponding container 3 to be operated is formed. The display 400 may be displayed in various types, a type of representing a designated color differing from colors represented by the output adjustment units 210 and 510 or a flickering type.

Further, a display 300 indicating output of the corresponding heating coils is formed. As shown in FIG. 6, the display 300 is displayed in characters, (P indicating a boost state, H indicating a high output state, L indicating a low output state, and S indicating a simmer state), or other various shapes, such as numerals. The length of the slide of the output adjustment unit 510 is proportional to the output of the corresponding heating coils. The output of the corresponding heating coils may be adjusted by adjusting the length of the slide of the output adjustment unit 510 by the user.

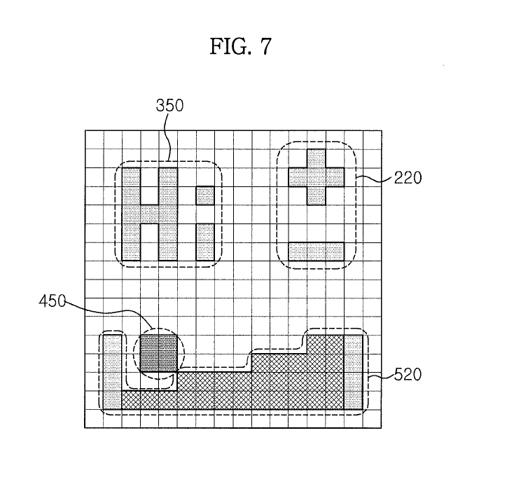

FIG. 7 is a plan view of an operation panel of an induction heating cooker, if a region displayed on the operation panel is touched to adjust output of heating coils on which a container is located, in accordance with a further embodiment.

When a user selects one of the regions displayed on the operation panel 6 in FIG. 4 by hand, an output adjustment unit 220 in the shape of + and − marks and an output adjustment unit 520 in the shape of slides are displayed. The two output adjustment units 220 and/or 520 may be displayed in various types, as shown in FIG. 5.

Further, a display 450 corresponding to positional data of heating coils to be operated is displayed. The display 450 may be displayed in various types, a type of representing a designated color differing from colors represented by the output adjustment units 220 and 520 or a flickering type. Further, a display 350 representing output of the corresponding heating coils is displayed. The display 350 may be displayed in various types, such as characters, as shown in FIG. 7, or numerals. The length of the slide of the output adjustment unit 520 is proportional to the output of the corresponding heating coils, and the output of the corresponding heating coils are adjusted by selecting one of the slides of the output adjustment unit 520 by the user.

The output adjustment units 200, 210, and 220 on the display unit 70, as shown in FIGS. 5 to 7, may be displayed on a separate display unit, and be included in a separate operation unit including keys, buttons, dials, or switches so as to serve as units to adjust output.

Further, a timer to adjust a heating time may be additionally provided. The timer may be displayed on the display unit 70 or a separate display unit, and be included in a separate operation unit including keys, buttons, dials, or switches, in the same manner as the output adjustment units 200, 210, and 220.

Although not shown in FIGS. 5 to 7, in accordance with one embodiment, temperatures measured by the temperature sensors 4 or heating times of containers 3 may be displayed on the display unit 70 or the outside of the display unit 70 as various shapes of numbers, characters, or slides.

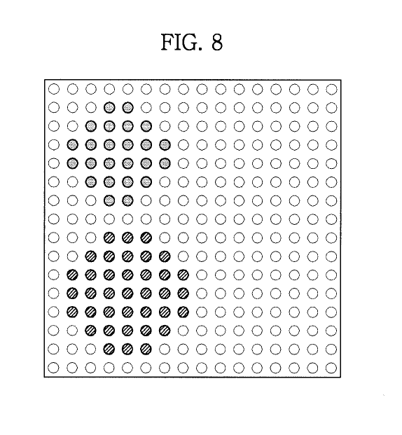

FIG. 8 is a plan view of a display unit of an induction heating cooker on which recognized containers are actually displayed in accordance with one embodiment.

FIG. 8 shows a screen of the display unit 70 of FIG. 4, displayed to a user. LEDs of the display unit 70 are configured to emit plurality of colors of light. FIG. 8 illustrates the operation panel 6 displaying that, if two containers 3 are placed on the cooking plate 2, the corresponding heating coils are divisionally represented in different colors.

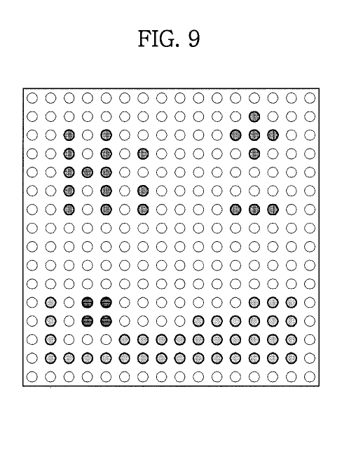

FIG. 9 is a plan view of an operation panel of an induction heating cooker on which a state of a recognized container and an output adjustment unit are actually displayed in accordance with another embodiment.

FIG. 9 shows a configuration of the operation panel 6 of FIG. 7, displayed to a user. The output adjustment units 220 and/or 520, the output display 350 and the position display 450 may be divisionally represented by LEDs of different colors or shapes.

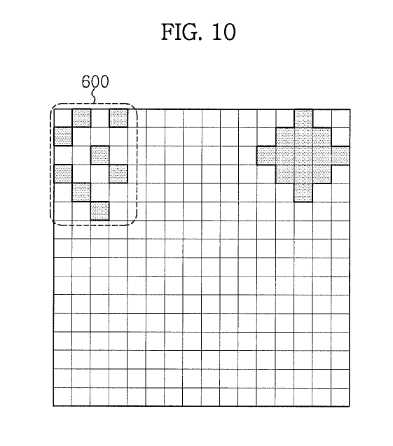

FIG. 10 is a plan view of an operation panel displaying remaining heat of an induction heating cooker after a container is removed in accordance with one embodiment.

At least one temperature sensor 4 is located under the cooking plate 2. The temperature sensors 4 sense a temperature of the cooking plate 2 or temperatures of the respective heating coils L before or after a container 3 is removed. Further, the temperature sensors 4 may sense temperatures between the cooking plate 2 and the respective heating coils L.

The sensed temperatures are transmitted to the control unit 60, and the control unit 60 controls the display unit 70 to represent the sensed temperatures as various shapes (600 or 700), such as different colors of the LEDs or a lattice shape, as shown in FIG. 10. Thereby, a user recognizes whether there is remaining heat in the induction heating cooking after the heating of the container 3, and is protected from danger of a burn. Further, the sensed temperatures may be separately displayed at the outside of the display unit 70.

When the sensed temperatures are input to the control unit 60, the control unit 60 decreases the output of the heating coils L if the input temperatures are greater than a designated reference value. Thereby, when the container 3 is excessively heated, the control unit 60 decreases the output of the heating coils, thus preventing the temperature of the heating coils from being excessively raised so as to cause malfunction of the heating coils.

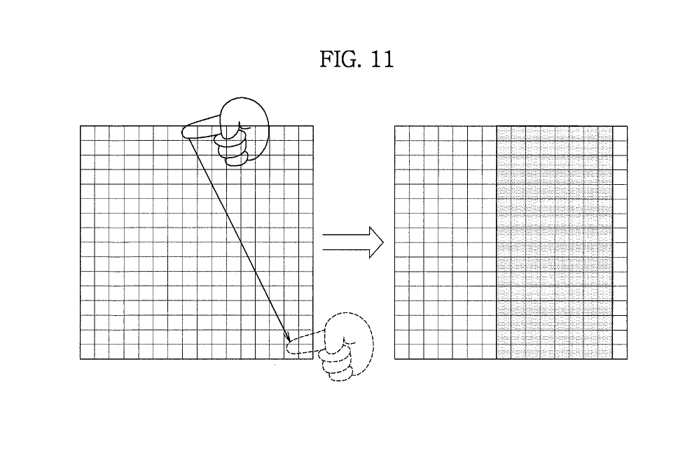

FIG. 11 is a plan view illustrating setting of a recognition region by hand, if whether containers are located on heating coils is not recognized, in accordance with one embodiment.

Although two or more containers 3 are disposed close to each other on the cooking plate 2, if the two or more containers 3 are placed on the cooking plate 2 with a time difference in a power-on state, the sensing units 50 judge that there are the two or more containers 3. However, if the two or more containers 3 are placed close to each other on the cooking plate 2 prior to the power-on state or are placed simultaneously and thus the control unit 60 has a difficulty in obtaining data of the containers 3, such as the number of the containers 3 or the sizes of the containers 3, or malfunctions, a container sensing region is manually set through drag on the operation panel 6 by user's finger, and thereby the control unit 60 judges whether the containers 3 are present on the heating coils L.

Further, differing from FIG. 11, if the containers 3 are not normally recognized, a warning informing the user of re-placing the containers 3 may be given. If two containers 3 are already placed or are simultaneously placed, the control unit 60 controls the display unit 70 to give a warning through colors, characters, or flickering. Further, a device to generate a warning sound may be additionally installed to inform the user of the mis-placement of the containers 3.

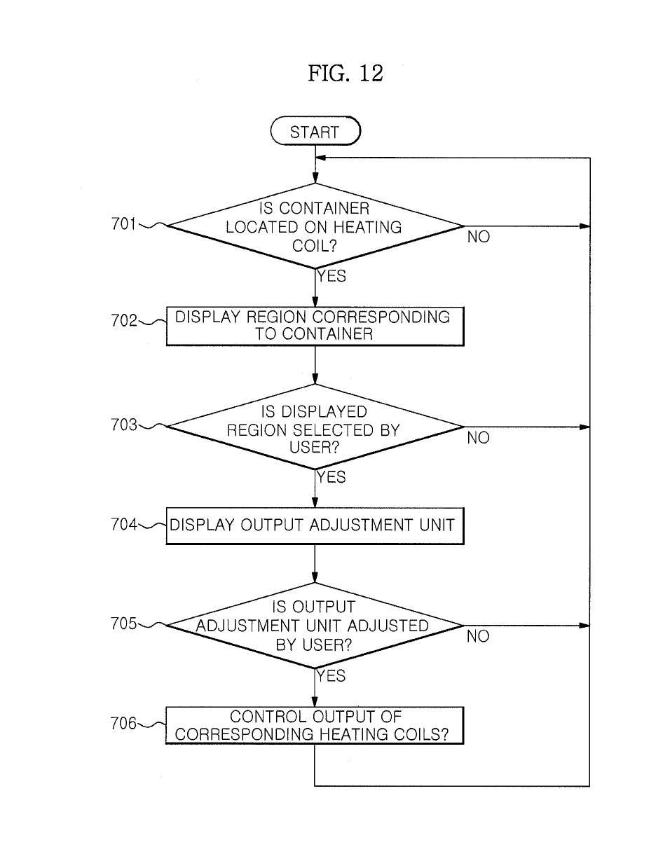

FIG. 12 is a flow chart illustrating an operating process of an induction heating cooker in accordance with one embodiment. Hereinafter, with reference to FIG. 12, the operating process of the induction heating cooker in accordance with this embodiment will be described.

The control unit 60 judges whether a container 3 is present based on signals of the sensing units 50 to sense the container 3 placed on the cooking plate 2 by a user. For example, the control unit 60 judges whether a container 3 is present based on the signals of the sensing units 50 sensing a change of an electrical signal, such as current or voltage of heating coils L on which the container 3 is located. When the sensed signal is not detected, the control unit 60 controls the sensing units 50 to again sense a change of the electrical signal (operation 701), and when the sensed signal is detected, the display unit 70 displays a designated region corresponding to the sensed container 3 (operation 702).

The control unit 60 judges whether the designated region corresponding to the sensed container 3 is selected by the user. When the designated region is not selected by the user, the control unit 60 repeats the judgment as to whether a container 3 is present, and when the designated region is selected by the user, the operation panel 6 displays the output adjustment unit 200, 210, or 220 to adjust the output of the heating coils L corresponding to the designated region (operation 703 and operation 704). When the displayed output adjustment unit 200, 210, or 220 is not adjusted by the user, the control unit 60 repeats the judgment as to whether a container 3 is present, and when the displayed output adjustment unit 200, 210, or 220 is adjusted by the user, the control unit 60 controls the corresponding heating coils L (operation 705 and operation 706).

Further, the control unit 60 may be configured such that, when the adjustment of the output of heating coils corresponding to a selected container 3 out of plural containers 3 is completed, the operation panel 6 is returned to an initial screen state displaying the plural containers 3 after a designated time elapses to adjust the output of another container 3 selected by the user, or the operation panel 6 is returned to the initial screen state displaying the plural containers 3 by selecting a designated region of the operation panel 6 by the user. Here, the designated region may be a region corresponding to the sensed container 3 or another operation unit. Further, the operation unit to return the operation panel 6 to the initial screen state may be formed on another display unit, including of keys, buttons, dials, or switches, installed separately from the display unit 70.

Further, a timer may be additionally located on the operation panel 6, or may be located on another display unit, and the corresponding container 3 may be heated for a time, desired by the user, through the timer. The timer may be installed on another operation unit, separately installed at the outside of the operation panel 6, in the shape of keys, buttons, dials, or switches. However, it is not limited thereto.

The operating process of the induction heating cooker, as shown in FIG. 12, is carried out if at least one container 3 is located on the cooking plate 2 with the plural heating coils L. On the other hand, if a container 3 is located on the cooking plate 2 with one heating coil L, the induction heating cooker may be operated without operation 703 of FIG. 12. That is, regardless of user selection, the operation panel 6 displays a region corresponding to the sensed container 3 and the output adjustment unit 200, 210, or 220, as in FIG. 5.

As is apparent from the above description, in an induction heating cooker and a control method thereof in accordance with one embodiment, display as various shapes using an operation panel regardless of operating methods is possible, and a display unit and an operation unit are unified to reduce an area occupied by the induction heating cooker, thereby being advantageous in terms of space utility.

Although a few embodiments have been shown and described, it would be appreciated by those skilled in the art that changes may be made in these embodiments without departing from the principles and spirit of the embodiments, the scope of which is defined in the claims and their equivalents.

What is claimed is:

1. An induction heating cooker, comprising:
heating coils to heat a container;
sensing units to sense the container located on the heating coils; and
a display unit to display the sensed container.

2. The induction heating cooker according to claim 1, further comprising an output adjustment unit to adjust output of the heating coils.

3. The induction heating cooker according to claim 2, wherein the display unit has a function of an operation panel.

4. The induction heating cooker according to claim 3, wherein the operation panel comprises a plate is located at a uppermost position, operation unit is located under the plate, a display unit is located under the operation unit.

5. An induction heating cooker according to claim 3, wherein the operation panel comprising:
an upper electrode;
an upper transparent substrate formed on the upper electrode;
a lower electrode;
a lower transparent substrate formed on the lower electrode;
a first metal electrode formed on the upper electrode; and
a second metal electrode formed on the lower electrode, wherein the upper transparent substrate and the lower transparent substrate are with a designated space therebetween.

6. The induction heating cooker according to claim 3, wherein the display unit displays a user interface to control the output adjustment unit.

7. The induction heating cooker according to claim 2, wherein the output adjustment unit is a second display unit provided separately from the display unit.

8. The induction heating cooker according to claim 2, wherein a user interface of the output adjustment unit is formed in the shape of any one of dials, buttons, slides, or combinations thereof.

9. The induction heating cooker according to claim 1, wherein the display unit is provided in a size reduced from a length and a width of a cooking plate, on which the container is placed, in a designated rate.

10. The induction heating cooker according to claim 9, wherein the display unit displays the sensed container at a position of the display unit corresponding to an actual position of the sensed container on the cooking plate.

11. The induction heating cooker according to claim 10, wherein the display unit displays output of the heating coils located under the container.

12. The induction heating cooker according to claim 11, wherein the sensing units sense at least one container.

13. The induction heating cooker according to claim 12, wherein the display unit displays a region of a container selected by a user out of the at least one container.

14. The induction heating cooker according to claim 12, wherein the display unit is returned to a screen state in which the at least one container is displayed, if the region corresponding to the container is not selected for a designated time.

15. The induction heating cooker according to claim 9, further comprising temperature sensors to sense a temperature of the cooking plate or temperatures of the heating coils.

16. The induction heating cooker according to claim 15, wherein the display unit displays the temperature(s) sensed by the temperature sensors.

17. The induction heating cooker according to claim 16, wherein the display unit includes LEDs or LCDs.

18. The induction heating cooker according to claim 17, wherein the operation panel has a function of a touch panel.

19. The induction heating cooker according to claim 15, wherein the display unit includes LEDs or LCDs representing at least one color, and the temperatures of the heating coils are represented in different colors or shapes of the LEDs or the LCDs according to the temperatures.

20. The induction heating cooker according to claim 13, wherein the display unit displays the selected region by flickering.

21. The induction heating cooker according to claim 20, wherein the display unit, if the region displayed by flickering is re-selected, displays the re-selected region.

22. The induction heating cooker according to claim 1, wherein the sensing units sense the container by sensing of the heating coils on which the container is located.

23. The induction heating cooker according to claim 22, wherein the sensing units sense the container by sensing current or voltage flowing to the heating coils.

24. A control method of an induction heating cooker, comprising:
sensing a container located on heating coils by a sensor; and
displaying the sensed container on a display unit.

25. The control method according to claim 24, further comprising displaying an output adjustment unit to adjust output of the heating coils on the display unit, and operating the output adjustment unit.

26. A control method of an induction heating cooker, comprising:
sensing at least one container located on heating coils;
displaying the at least one sensed container on a display unit; and
adjusting output of a container selected by a user from the at least one container displayed on the display unit.
